(19) United States
(12) Patent Application Publication
(10) Pub. No.: US 2015/0077785 A1
(43) Pub. Date: Mar. 19, 2015

(54) IMAGE FORMING APPARATUS HAVING SECURE PRINTING FUNCTION, CONTROL METHOD THEREFOR, AND STORAGE MEDIUM

(71) Applicant: CANON KABUSHIKI KAISHA, Tokyo (JP)

(72) Inventor: Yuzo Harano, Sagamihara-shi (JP)

(21) Appl. No.: 14/480,931

(22) Filed: Sep. 9, 2014

(30) Foreign Application Priority Data
Sep. 17, 2013 (JP) 2013-191662

(51) Int. Cl. G06F 3/12

(52) U.S. Cl. CPC G06F 3/1222; G06F 3/1238; G06F 3/1274; G06F 3/1203
USPC 358/1.14

(57) ABSTRACT

An image forming apparatus which is capable of further improving safety and reliability of a secure printing function. Print data, which is received from an external apparatus, is stored as print data using the secure printing function in a storage unit. It is determined whether or not, during execution of a printing process started for the stored print data, a print aborting factor that aborts the printing process has occurred. The printing process is aborted when it is determined that the print aborting factor has occurred. When the printing process is aborted, the print data is stored once again as print data using the secure printing function in the storage unit.

### BACKGROUND OF THE INVENTION

1. Field of the Invention

The present invention relates to an image forming apparatus, a control method therefor, and a storage medium.

2. Description of the Related Art

Conventionally, image forming apparatuses have been equipped with functions of performing various types of processing on print jobs, and as one of those functions, there has been known a function of performing printing with security enhanced for print jobs (securely) (see, for example, Japanese Laid-Open Patent Publication (Kokai) No. 2000-76028).

This function is generally called secure printing, and for example, print job data with a password assigned thereto is transmitted from a client computer to an image forming apparatus. The transmitted print job data is stored in the image forming apparatus, and a print job waits for execution. In this state, when the password included in the stored print job data is input on an operation screen of the image forming apparatus, the print job is executed.

Thus, in secure printing, a print job is executed by a user who executes the print job directly operating the image forming apparatus such as input of a password. As a result, situations in which printed matter is seen by other users, taken by mistake, stolen on purpose, and left can be avoided.

However, there may be cases where printing cannot be immediately started or printing cannot be continued and is suspended due to occurrence of an interruption caused by warm-up of the image forming apparatus, various adjustments, or the like immediately before a print job is started or before a print job is completed. Examples of such interruptions include those caused by warm-up of the image forming apparatus, color adjustment, temperature adjustment, cleaning process, return from sleep mode, shortage of consumables such as toner and printing sheets, and retention of other preceding print job.

While a user is temporarily away from the image forming apparatus when printing is waiting to be started or suspended because of some problem in the image forming apparatus, printing may be started or resumed. Also, some users may forget he or she executed a print job and may not come back.

Namely, if a user leaves the image forming apparatus due to some problem in the image forming apparatus, printed matter may be discharged while he or she is away from the image forming apparatus, and hence effects expected from secure printing cannot be obtained.

### SUMMARY OF THE INVENTION

The present invention provides an image forming apparatus and a control method therefor, which are capable of further improving safety and reliability of a secure printing function, as well as a computer-readable storage medium storing a program for implementing the control method.

Accordingly, a first aspect of the present invention provides an image forming apparatus having a secure printing function, comprising a storage unit configured to store print data, which is received from an external apparatus, as print data using the secure printing function, a printing unit configured to execute a printing process on the print data in response to a printing instruction which the image forming apparatus have received from a user, a detection unit configured to detect a print aborting factor during execution of the printing process, a control unit configured to abort the printing process in response to detection of the print aborting factor, and store the print data once again as print data using the secure printing function in the storage unit.

Accordingly, a second aspect of the present invention provides a control method for an image forming apparatus having a secure printing function, comprising a storage step of storing print data, which is received from an external apparatus, as print data using the secure printing function, a printing step of executing a printing process on the print data in response to a printing instruction which the image forming apparatus have received from a user, a detection step of detecting a print aborting factor during execution of the printing process, a control step of aborting the printing process in response to detection of the print aborting factor, and storing the print data once again as print data using the secure printing function.

Accordingly, a third aspect of the present invention provides a non-transitory computer-readable storage medium storing a program for causing a computer to execute a control method for an image forming apparatus having a secure printing function, the control method comprising a storage step of storing print data, which is received from an external apparatus, as print data using the secure printing function, a printing step of executing a printing process on the print data in response to a printing instruction which the image forming apparatus have received from a user, a detection step of detecting a print aborting factor during execution of the printing process, a control step of aborting the printing process in response to detection of the print aborting factor, and storing the print data once again as print data using the secure printing function.

According to the present invention, when a factor that is determined in advance and aborts execution of a printing process occurs during execution of the printing process started by a user performing a printing operation using the image forming apparatus, the printing process is aborted, and print data is stored once again as print data using the secure printing function in the storage section. Therefore, printed matter is never output accidently, and in addition, when printing is to be performed once again, a printing operation is required to be performed one more time. Thus, even if during execution of a print job using the secure printing function, a user who has provided an instruction to execute the print job leaves the image forming apparatus, safety and reliability of the secure printing function can be further improved.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of an image forming system including an image forming apparatus according to an embodiment of the present invention.

FIG. 2 is a diagram schematically showing an arrangement of the image forming apparatus in FIG. 1.

FIG. 3 is a view which is useful in explaining operation of a PC and the image forming apparatus in FIG. 1 when they perform secure printing.

FIG. 4 is a view which is useful in explaining operation of the image forming apparatus in FIG. 1 when it performs secure printing.

FIG. 5 is a view showing an operation unit in FIG. 1 and an exemplary initial setting screen displayed on a display unit of the operation unit.

FIG. 6 is a view showing an exemplary execution aborting notification screen displayed on the display unit.

FIG. 7 is a flowchart showing a procedure of a printing control process which is carried out by a CPU in FIG. 1.

FIG. 8 is a flowchart showing a procedure of a secure printing control process which is carried out by the CPU.

FIG. 9 is a view showing another exemplary initial setting screen displayed on the display unit.

FIG. 10 is a flowchart showing another procedure of a secure printing control process which is carried out by the CPU.

### DESCRIPTION OF THE EMBODIMENTS

The present invention will now be described in detail with reference to the drawings showing an embodiment thereof.

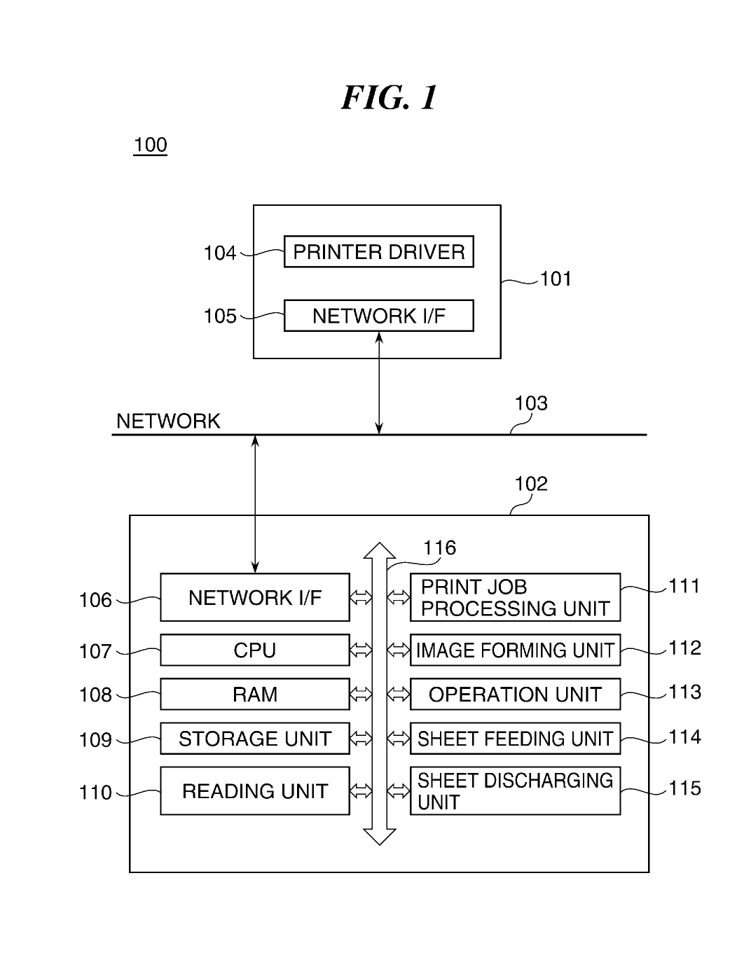

FIG. 1 is a diagram schematically showing an arrangement of an image forming system 100 including an image forming apparatus 102 according to an embodiment of the present invention.

Referring to FIG. 1, the image forming system 100 is comprised of the image forming apparatus 102 and a PC 101, which is an external apparatus, and they are connected to each other via a network 103. The PC 101 has a printer driver 104 and is connected to the network 103 via a network interface 105. The external apparatus is not limited to the PC, but may be a tablet terminal, a smartphone, or the like as long as it is a computer having a function of sending print data.

The PC 101 transmits print job data (print data), which is data for executing a print job including PDL data described in a page description language (PDL) such as PS (PostScript) or PCL (Printer Control Language), to the image forming apparatus 102 via the printer driver 104 in accordance with a printing instruction from an installed application. The print job data includes printing information such as print settings and an attribute as well as the PDL data and may also include a password or the like. It should be noted that in the present embodiment, an attribute means information indicative of printing using a secure printing function, to be described later (hereafter referred to as “secure printing”), or normal printing.

The image forming apparatus 102 includes a network interface 106, a CPU 107, a RAM 108, a storage unit 109, a reading unit 110, a print job processing unit 111, an image forming unit 112, an operation unit 113, a sheet feeding unit 114, and a sheet discharging unit 115, and they are connected to one another via a bus 116.

The CPU 107 controls the entire image forming apparatus 102. The RAM 108 stores various programs, which are executed by the CPU 107, and various data and is also used as a work area for the CPU 107. The storage unit 109, which is a nonvolatile storage device such as a hard disk, stores various programs and various data which are to be expanded on the RAM 109.

The reading unit 110 is a scanner, and the image forming unit 112 is a printer. The print job processing unit 111 subjects a print job to image processing in accordance with an attribute of print job data, converts the print job into raster data on a page-by-page basis, and outputs the raster data as print image data printable by the image forming unit 112.

The sheet feeding unit 114 feeds recording media such as print sheets to the image forming unit 112. Recording media with images printed thereon by the image forming unit 112 are discharged to the sheet feeding unit 115. The operation unit 113 displays information for a user and receives user operations. The network interface 106 is an interface to the network 103.

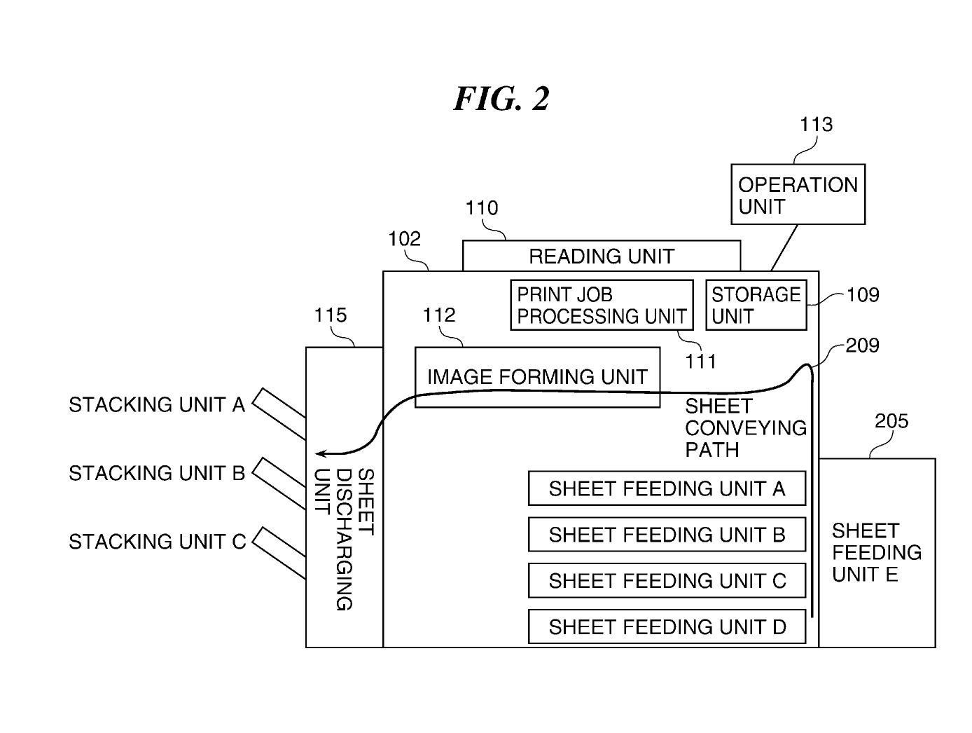

FIG. 2 is a diagram schematically showing an arrangement of the image forming apparatus 102 in FIG. 1.

The image forming apparatus 102 has sheet feeding units A to E and stacking units A to C as well as the constituent elements described above with reference to FIG. 1. Recording media fed from the sheet discharging unit 115 are stacked in the stacking units A to C.

When printing is started, a recoding medium is fed from any of the sheet feeding units A to E and conveyed to the image forming unit 112 via a sheet conveying path 209. After an image is formed on the recoding medium by the image forming unit 112, the recording medium is placed in any of the stacking units A to C by way of the sheet discharging unit 115.

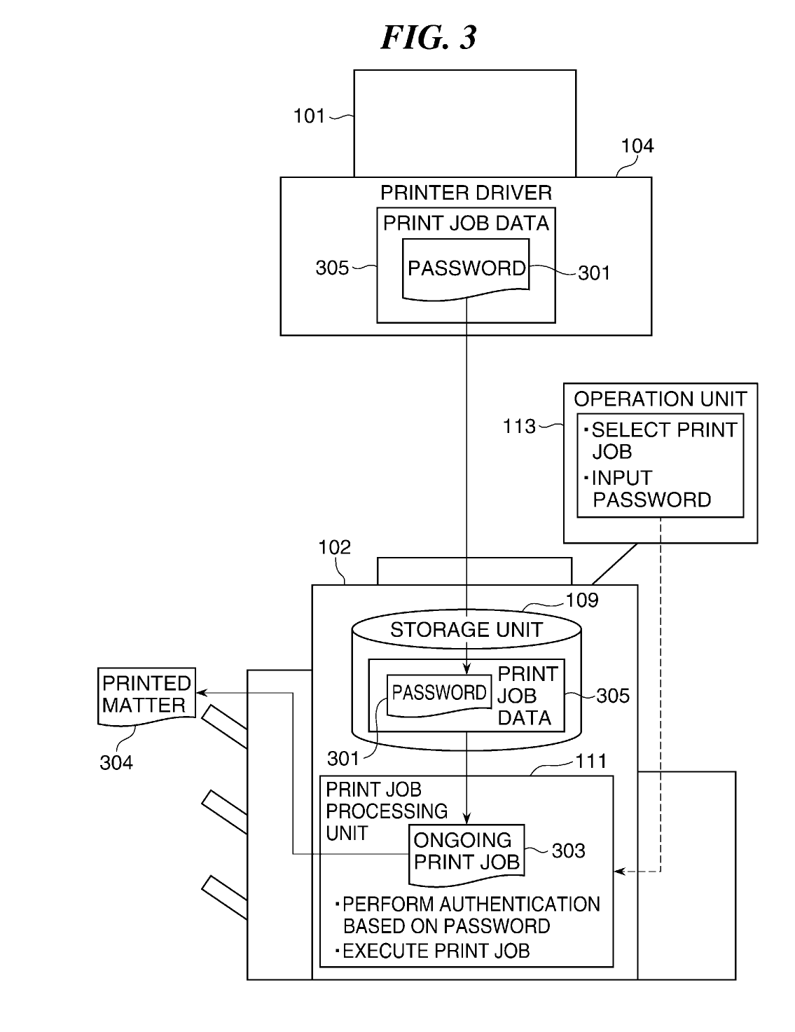

FIG. 3 is a view which is useful in explaining operation of the PC 101 and the image forming apparatus 102 in FIG. 1 when they perform secure printing.

Referring to FIG. 3, print job data 305 having an attribute of secure printing includes a password 301 specified by a user and is generated by the printer driver 104 of the PC 101.

Then, the print job data 305 including the password 301, which is transmitted from the PC 101, is spooled and stored as print job data of a print job for secure printing in the storage unit 109 of the image forming apparatus 102.

Then, on the operation unit 113 of the image forming apparatus 102, the user who has sent the print job data 305 selects the print job of the print job data 305 stored in the storage unit 109 and inputs a password. The print job processing unit 111 obtains the password 301 included in the print job data 305 and compares the password input on the operation unit 113 by the user and the password 301 with each other. As a result of the password comparison, when they match, the print job processing unit 111 executes the print job of the print job data 305 and continues a printing process as an ongoing print job 303.

It should be noted that in the description of the present embodiment, a process leading from selection of a print job and input of a correct password on the operation unit 113 by the user to complete discharging of a print job as printed matter 304 from the image forming apparatus 102 is referred to as a print job (printing process).

Finally, the print job processing unit 111 discharges the ongoing print job 303 as the printed matter 304, normally terminates the printing process, and then erases data relating to the print job data 305 temporarily stored in the storage unit 109 and the ongoing print job 303 used as intermediate data.

Data erasure, which aims to secure confidentiality, is performed so as to disable operations such as edition, duplication, and browsing of the print job data 305 and re-execution of the print job of the print job data 305 after a printing process is normally terminated.

As described above, when the image forming apparatus 102 receives print job data including the password 301 from the PC 101, it stores the print job data 305. After that, when the user who has sent the print job data 305 from the PC 101 selects a print job of the print job data 305 and inputs a password for the print job, the image forming apparatus 102 extracts the password 301 included in the print job data 305. The image forming apparatus 102 then compares the input password and the password 301 extracted from the print job data 305, and when they match, executes the print job.

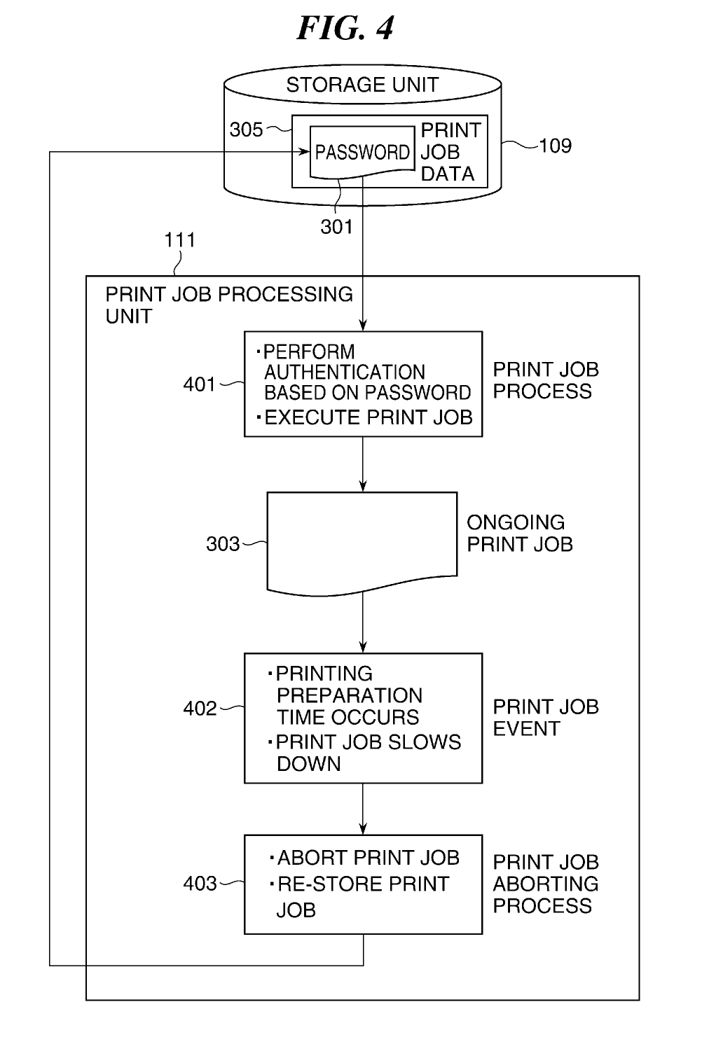

FIG. 4 is a view which is useful in explaining operation of the image forming apparatus 102 in FIG. 1 when it performs secure printing.

Referring to FIG. 4, the print job processing unit 111 obtains the print job data 305 including the password 301 from the storage unit 109 and carries out a print job process 401. In the print job process 401, the print job processing unit 111 extracts the password 301 from the print job data 305, compares the extracted password 301 and the password input by the user on the operation unit 113, and when they match, executes the print job of the print job data 305 and continues a printing process as the ongoing print job 303.

Here, in the image forming apparatus 102, because a wide variety of status changes occur during operation, a description will be given of a case where during processing on the ongoing print job 303, such a print job event 402 as to slow down a printing process on the ongoing print job 303, for example, some printing preparation time occurs in the image forming apparatus 102.

As described above, examples of the print job event 402 include warm-up of the image forming apparatus 102, color adjustment, temperature adjustment, cleaning processing, return from sleep mode, shortage of consumable items such as toner and printing sheets, and retention of other preceding print jobs.

When the print job event 402 that slows the progress of and suspends the printing process on the ongoing print job 303 occurs, processing on the ongoing print job 303 may be slowed down and suspended.

When the print job event 402 occurs to slow down processing on the ongoing print job 303, the image forming apparatus 102 carries out a print job aborting process 403. The print job aborting process 403 aborts execution of the ongoing print job 303 and brings the image forming apparatus 102 back to a state before execution of the ongoing print job 303, that is, a state in which print job data is stored in the storage unit 109. In the following description, the print job event 402 may be expressed merely as a print aborting factor.

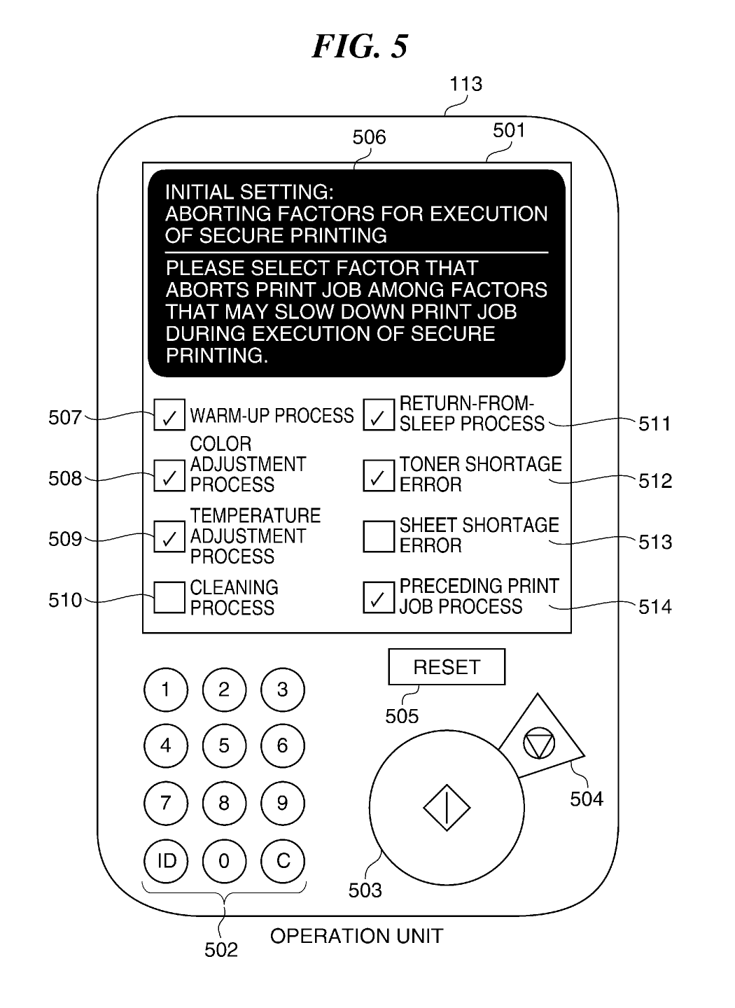

FIG. 5 is a view showing the operation unit 113 in FIG. 1 and an exemplary initial setting screen displayed on a display unit 501 of the operation unit 113.

Referring to FIG. 5, the operation unit 113 has the display unit 501, an entry keypad 502, a start key 503, a stop key 504, and a reset key 505.

The display unit 501, which is a touch-panel type LCD, is a user interface for a user to perform operation, configuration, and so forth on the image forming apparatus 102. The entry keypad 502 includes a numeric keypad, a clear key for clearing entries, and so on. The start key 503 is a key for providing instructions to start a print job, a facsimile job, and so on.

The stop key 504 is a key for providing an instruction to stop the ongoing print job 303 or the like. The reset key 505 is a key for returning an input value or a setting value to an initial value and causing transition of a currently-displayed screen to an initial screen or a parent screen.

An initial setting screen including an initial setting message 506 and selection items 507 to 514 is displayed on the display unit 501. The initial setting message 506 is a message that prompts the user to select a print aborting factor for which secure printing is to be aborted. The selection items 507 to 514 are items from which the user selects a print aborting factor, and when the user enters a checkmark in a checkbox to select any of the selection items 507 to 514, the selected item is set as a print aborting factor.

Namely, the selection items 507 to 514 are items for the user to selectively set individual factors in a manner consistent with the manner of operation by the user of the image forming apparatus 102 and his/her requirements, and they are not items for fixedly setting all of various factors that slow down the progress of a print job as factors for aborting execution of secure printing.

In the present embodiment, it is assumed that the selection items 507 to 510 are a warm-up process, a color adjustment process, a temperature adjustment process, and a cleaning process, respectively.

It is also assumed that the selection items 511 to 514 are a return-from-sleep process, a toner shortage error, a sheet shortage error, and a prior printing job process, respectively. These selection items are examples, and accordingly, a selection item may be deleted or another selection item may be added.

In the example shown in FIG. 5, the warm-up process, the color adjustment process, the temperature adjustment process, the return-from-sleep process, the toner shortage error, and the preceding printing job process are selected as print aborting factors.

Thus, when a print aborting factor selected by the user occurs during execution of a print job, the print job aborting process 403 is carried out to bring the image forming apparatus 102 back to a state before execution of the print job, that is, a state in which the print job data 305 is stored in the storage unit 109.

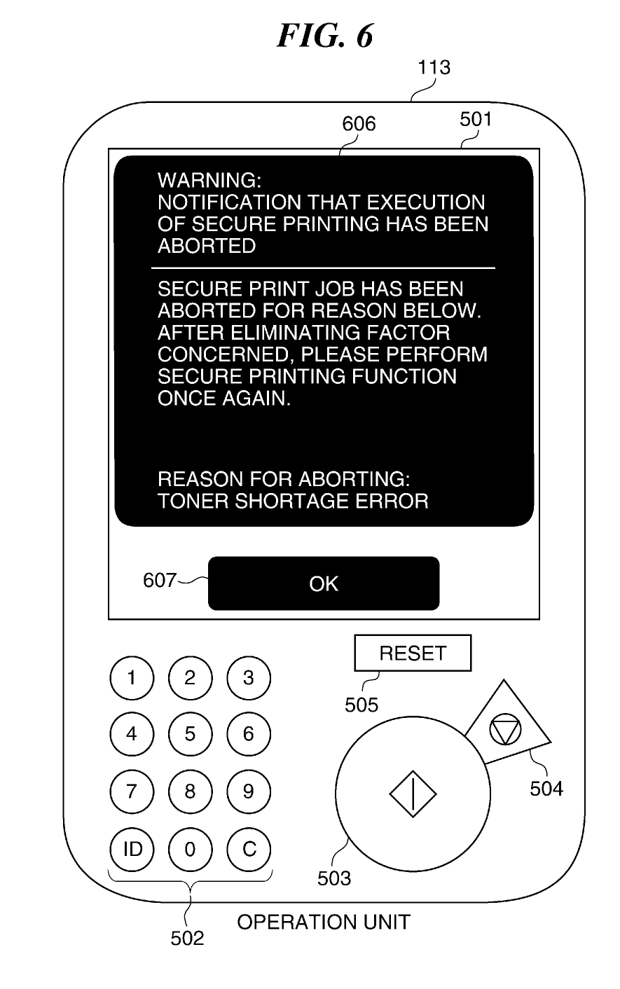

FIG. 6 is a view showing an exemplary execution aborting notification screen displayed on the display unit 501 of the operation unit 113 in FIG. 1.

Referring to FIG. 6, the execution aborting notification screen including a warning message 606 and an OK button 607 are displayed on the display unit 501. The warning message 606 notifies the user that a print job has been aborted in a case where after the start of a printing process on the print job having an attribute of secure printing, the progress of the print job is slowed down for some reason and execution of the print job is aborted. At this time, a reason why the print job was aborted as well as the warning message 606 may be displayed.

When the user depresses the OK button 607, it is determined that the user has confirmed the warning message 606, and the display of the warning message 606 exits.

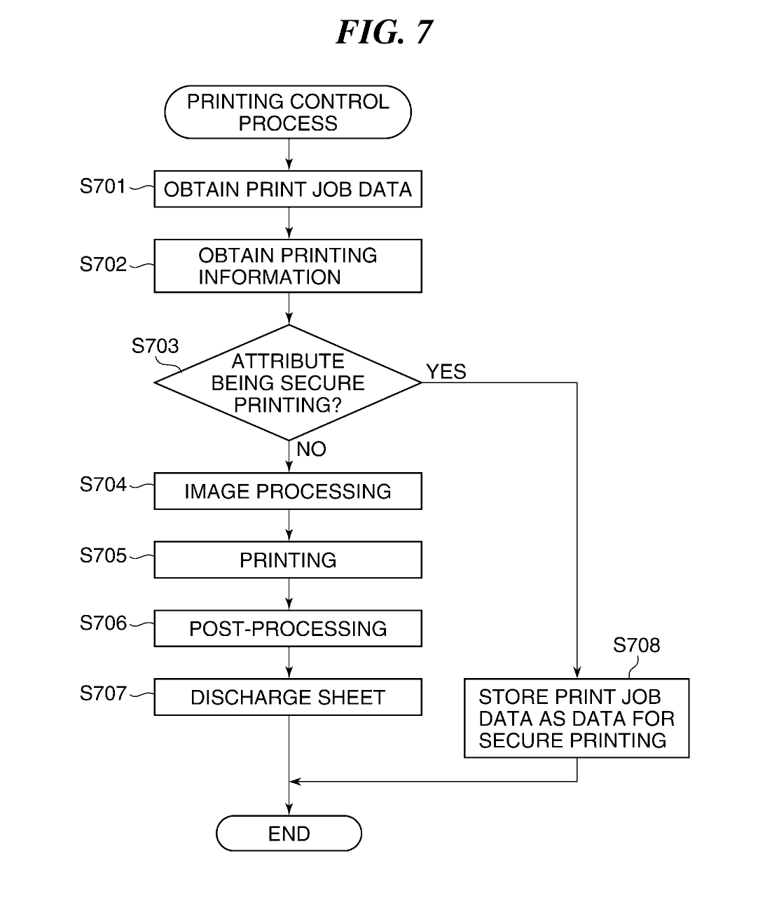

FIG. 7 is a flowchart showing a procedure of a printing control process which is carried out by the CPU 107 in FIG. 1.

First, the print job processing unit 111 obtains the print job data 305 from the PC 101 and stores the obtained print job data 305 in the storage unit 109 (step S701). The print job processing unit 111 then analyzes the print job data 305 to obtain printing information on a print job such as an attribute and print settings (step S702).

The print job processing unit 111 then determines whether or not the attribute of the print job data 305 is secure printing (step S703). As a result of the determination in the step S703, when the attribute of the print job data 305 is secure printing (YES in the step S703), the print job processing unit 111 stores the print job data 305 as secure print data in the storage unit 109 (step S708: storage unit) and terminates the process.

On the other hand, as a result of the determination in the step S703, when the attribute of the print job data 305 is not secure printing (NO in the step S703), the print job processing unit 111 performs image processing such as RIP on PDL data included in the print job to obtain raster data (step S704).

The print job processing unit 111 then transfers the raster data obtained in the step S704 to the image forming unit 112 and instructs the image forming unit 112 to carry out a printing process, whereby the printing process is carried out to generate the printed matter 304 (step S705).

The print job processing unit 111 then provides an instruction to perform post-processing on the generated printed mater 304. As a result, the printed matter 304 is subjected to specified post-processing while it is being conveyed to any of the stacking units A to C by way of the sheet discharging unit 115 (step S706).

Then, in accordance with an instruction from the print job processing unit 111, the printed matter 304 subjected to the post-processing is discharged to any of the stacking units A to C (step S707), followed by termination of the process. It should be noted that when the attribute of the print job data 305 is not secure printing (when the process proceeds to the step S707 from NO in the step S703), a normal printing process is carried out.

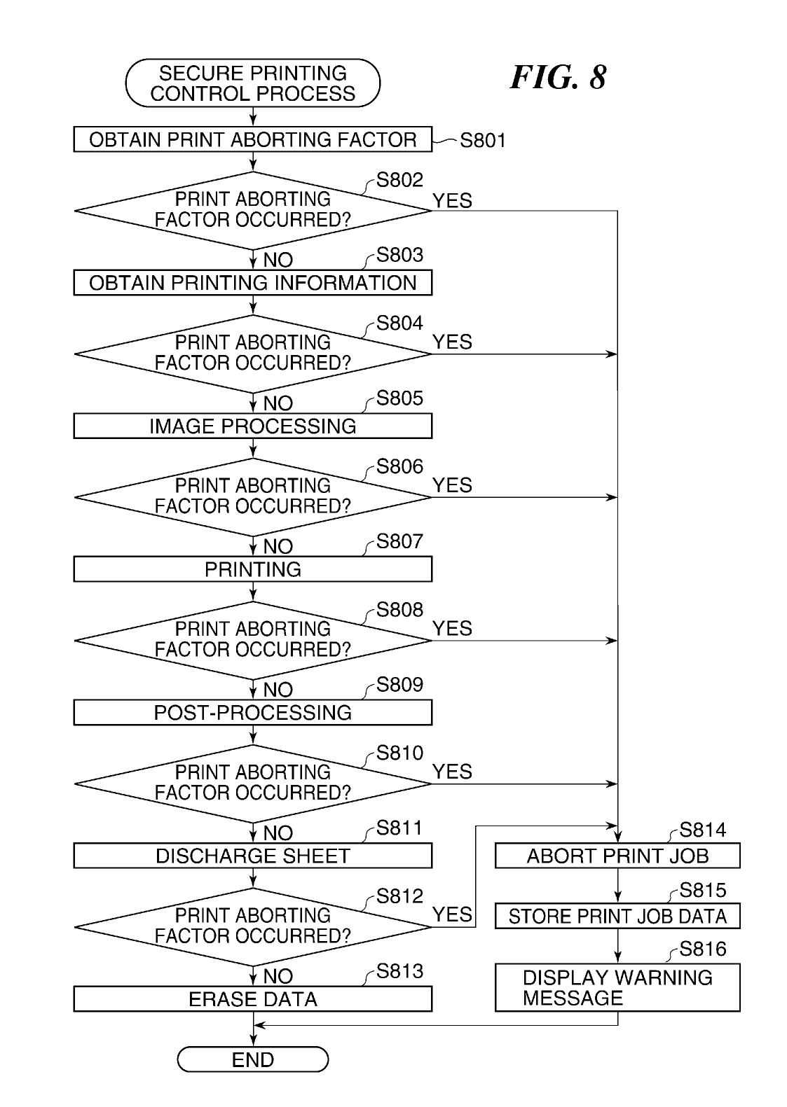

FIG. 8 is a flowchart showing a procedure of a secure printing control process which is carried out by the CPU 107 in FIG. 1.

The secure printing control process in FIG. 8 is carried out when the password input on the operation unit 113 by the user who has sent the print job data 305 from the PC 101 and the password 301 included in the print job data 305 stored in the storage unit 109 in the step S708 in FIG. 7 are compared with each other, and they match.

First, the print job processing unit 111 obtains print aborting factors set on the initial setting screen in FIG. 5 (step S801). The print job processing unit 111 then determines whether or not any of the print aborting factors obtained in the step S801 has occurred (step S802).

As a result of the determination in the step S802, when it is detected that any of the obtained print aborting factors has occurred (YES in the step S802), the print job processing unit 111 aborts the ongoing print job (step S704).

The print job processing unit 111 then stores the print job data 305 on the aborted print job once again in the storage unit 109 as print job data for secure printing (step S815). The print job processing unit 111 then displays the warning message 606 in FIG. 6 on the display unit 501 (step S816) and terminates the process.

Reverting to the step S802, as a result of the determination in the step S802, when none of the print aborting factors obtained in the step S801 has occurred (NO in the step S802), the print job processing unit 111 analyzes the print job data 305 to obtain printing information such as an attribute of and print settings on the print job (step S803).

The print job processing unit 111 then determines whether or not any of the obtained print aborting factors has occurred (step S804). As a result of the determination in the step S804, when it is detected that any of the obtained print aborting factors has occurred (YES in the step S804), the process proceeds to the step S814.

On the other hand, as a result of the determination in the step S804, when none of the obtained print aborting factors has occurred (NO in the step S804), the print job processing unit 111 performs image processing such as RIP on PDL data included in the print job to obtain raster data (step S805).

The print job processing unit 111 then determines whether or not any of the print aborting factors obtained in the step S801 has occurred (step S806). As a result of the determination in the step S806, when it is detected that any of the obtained print aborting factors has occurred (YES in the step S806), the process proceeds to the step S814.

On the other hand, as a result of the determination in the step S806, when none of the obtained print aborting factors has occurred (NO in the step S806), the print job processing unit 111 transfers the raster data obtained in the step S805 to the image forming unit 112 and instructs the image forming unit 112 to carry out a printing process. As a result, the printing process is carried out to generate the printed matter 304 (step S807).

The print job processing unit 111 then determines whether or not any of the print aborting factors obtained in the step S801 has occurred (step S808). As a result of the determination in the step S808, when it is detected that any of the obtained print aborting factors has occurred (YES in the step S808), the process proceeds to the step S814.

On the other hand, as a result of the determination in the step S808, when none of the obtained print aborting factors has occurred (NO in the step S808), the print job processing unit 111 provides an instruction to perform post-processing on the printed matter 304 generated in the step S807. As a result, the printed matter 304 is subjected to specified post-processing while it is being conveyed to any of the stacking units A to C by way of the sheet discharging unit 115 (step S809).

The print job processing unit 111 then determines whether or not any of the print aborting factors obtained in the step S801 has occurred (step S810). As a result of the determination in the step S810, when it is detected that any of the obtained print aborting factors has occurred (YES in the step S810), the process proceeds to the step S814.

On the other hand, as a result of the determination in the step S810, when none of the obtained print aborting factors has occurred (NO in the step S810), the print job processing unit 111 provides an instruction to discharge the printed matter 304 subjected to the post-processing to any of the stacking units A to C (step S811).

The print job processing unit 111 then determines whether or not any of the print aborting factors obtained in the step S801 has occurred (step S812). As a result of the determination in the step S812, when it is detected that any of the obtained print aborting factors has occurred (YES in the step S812), the process proceeds to the step S814.

On the other hand, as a result of the determination in the step S812, when none of the obtained print aborting factors has occurred (NO in the step S812), the print job processing unit 111 erases data relating to the print job data 305 temporarily stored in the storage unit 109 and the ongoing print job 303 used as intermediate data (step S813) and terminates the process. It should be noted that the steps S802, S804, S806, S808, S810, and S812 correspond to a detection unit.

In the secure printing control process described above, a print job is immediately aborted when a print aborting factor occurs, but not only a condition that a print aborting factor has occurred but also a condition that a time period determined in advance has elapsed since a print aborting factor occurred may be additionally provided as a condition for aborting a print job.

This aims to flexibly set a time period that elapses before a print job is actually aborted according to a usage environment for the image forming apparatus 102 and use and needs of a user.

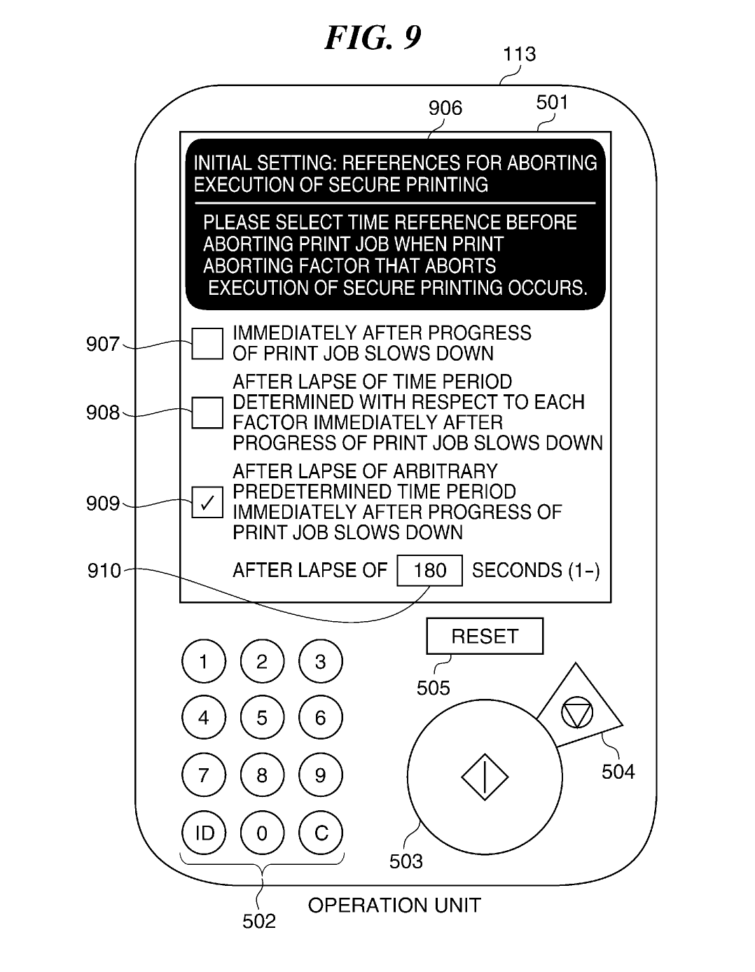

FIG. 9 is a view showing another exemplary initial setting screen displayed on the display unit 501 of the operation unit 113 in FIG. 1.

Referring to FIG. 9, an initial setting message 906, which prompts the user to select a print aborting factor for execution of secure printing, is displayed on the initial setting screen of the display unit 501 as setting items of the image forming apparatus 102. Selection items 907 to 909 are also displayed on the display unit 501.

The selection item 907 is an item for immediately aborting a print job after a print aborting factor occurs. The selection item 908 is an item for aborting a print job upon the lapse of a time period determined in advance after occurrence of a print aborting factor. This timed period determined in advance is set with respect to each aborting target factor.

The selection item 909 is an item for aborting a print job upon the lapse of a time period determined in advance by the user after occurrence of a print aborting factor. This timed period determined in advance corresponds to a time period entered into the input field 910 by the user, and the user is allowed to set a desired time period.

Because the user can select a plurality of conditions for aborting a print job according to his/her mode of usage as shown on the initial setting screen in FIG. 9, demands of the user can be satisfied to the maximum extent possible.

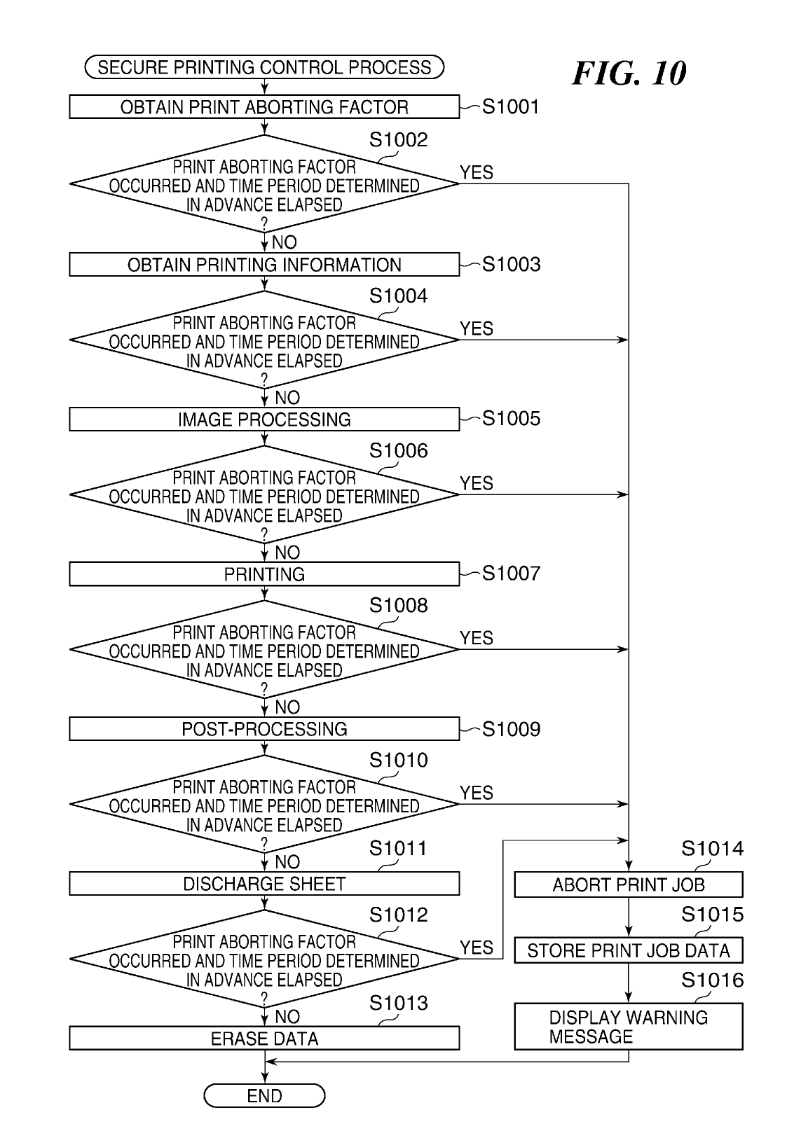

FIG. 10 is a flowchart showing a procedure of a secure printing control process which is carried out by the CPU 107 in FIG. 1.

The secure printing control process in FIG. 10 is carried out when the password input on the operation unit 113 by the user who has sent the print job data 305 from the PC 101 and the password 301 included in the print job data 305 stored in the storage unit 109 are compared with each other, and they match.

First, the print job processing unit 111 obtains print aborting factors set on the initial setting screen in FIG. 5 and a time period determined in advance set on the initial setting screen in FIG. 9 (step S1001). Specifically, as the time period determined in advance, the print job processing unit 111 obtains “0” when the selection item 907 is selected on the initial setting screen in FIG. 9, obtains a time period determined with respect to each factor when the selection item 908 is selected, and obtains a time period input by the user when the selection item 909 is selected.

The print job processing unit 111 then determines whether or not any of the print aborting factors obtained in the step S1001 has occurred, and the time period determined in advance has elapsed since the occurrence of the print aborting factor (step S1002). As a result of the determination in the step S1002, when any of the obtained print aborting factors has occurred, and the time period determined in advance has elapsed since the occurrence of the print aborting factor (YES in the step S1002), the print job processing unit 111 aborts the ongoing print job (step S1014).

The print job processing unit 111 then stores the print job data 305 on aborted the print job once again as print job data for secure printing in the storage unit 109 (step S1015). The print job processing unit 111 then displays the warning message 606 in FIG. 6 on the display unit 501 (step S1016) and terminates the process.

Reverting to the step S1002, as a result of the determination in the step S1002, when none of the print aborting factors obtained in the step S1001 has occurred, or the time period determined in advance has not elapsed since the occurrence of the print aborting factor (NO in the step S1002), the print job processing unit 111 analyzes the print job data 305 to obtain printing information such as an attribute of and print settings on the print job (step S1003).

The print job processing unit 111 then determines whether or not any of the print aborting factors obtained in the step S1001 has occurred, and the time period determined in advance has elapsed since the occurrence of the print aborting factor (step S1004). As a result of the determination in the step S1004, when any of the obtained print aborting factors has occurred, and the time period determined in advance has elapsed since the occurrence of the print aborting factor (YES in the step S1004), the process proceeds to the step S1014.

On the other hand, as a result of the determination in the step S1004, when none of the print aborting factors obtained in the step S1001 has occurred, or the time period determined in advance has not elapsed since the occurrence of the print aborting factor (NO in the step S1004), the print job processing unit 111 performs image processing such as RIP on PDL data included in the print job to obtain raster data (step S1005).

The print job processing unit 111 then determines whether or not any of the print aborting factors obtained in the step S1001 has occurred, and the time period determined in advance has elapsed since the occurrence of the print aborting factor (step S1006). As a result of the determination in the step S1006, when any of the obtained print aborting factors has occurred, and the time period determined in advance has elapsed since the occurrence of the print aborting factor (YES in the step S1006), the process proceeds to the step S1014.

On the other hand, as a result of the determination in the step S1006, when none of the obtained print aborting factors has occurred, or the time period determined in advance has not elapsed since the occurrence of the print aborting factor (NO in the step S1006), the print job processing unit 111 transfers the raster data obtained in the step S1005 to the image forming unit 112 and instructs the image forming unit 112 to carry out a printing process. As a result, the printing process is carried out to generate the printed matter 304 (step S1007).

The print job processing unit 111 then determines whether or not any of the print aborting factors obtained in the step S1001 has occurred, and the time period determined in advance has elapsed since the occurrence of the print aborting factor (step S1008). As a result of the determination in the step S1008, when any of the obtained print aborting factors has occurred, and the time period determined in advance has elapsed since the occurrence of the print aborting factor (YES in the step S1008), the process proceeds to the step S1014.

On the other hand, as a result of the determination in the step S1008, when none of the obtained print aborting factors has occurred, or the time period determined in advance has not elapsed since the occurrence of the print aborting factor (NO in the step S1008), the print job processing unit 111 provides an instruction to perform post-processing on the printed mater 304 generated in the step S1007. As a result, the printed matter 304 is subjected to specified post-processing while it is being conveyed to any of the stacking units A to C by way of the sheet discharging unit 115 (step S1009).

The print job processing unit 111 then determines whether or not any of the print aborting factors obtained in the step S1001 has occurred, and the time period determined in advance has elapsed since the occurrence of the print aborting factor (step S1010). As a result of the determination in the step S1010, when any of the obtained print aborting factors has occurred, and the time period determined in advance has elapsed since the occurrence of the print aborting factor (YES in the step S1010), the process proceeds to the step S1014.

On the other hand, as a result of the determination in the step S1010, when none of the obtained print aborting factors has occurred, or the time period determined in advance has not elapsed since the occurrence of the print aborting factor (NO in the step S1010), the print job processing unit 111 provides an instruction to discharge the printed matter 304 subjected to the post-processing to any of the stacking units A to C (step S1011).

The print job processing unit 111 then determines whether or not any of the print aborting factors obtained in the step S1001 has occurred, and the time period determined in advance has elapsed since the occurrence of the print aborting factor (step S1012).

As a result of the determination in the step S1012, when any of the obtained print aborting factors has occurred, and the time period determined in advance has elapsed since the occurrence of the print aborting factor (YES in the step S1012), the process proceeds to the step S1014.

On the other hand, as a result of the determination in the step S1012, when none of the obtained print aborting factors has occurred, or the time period determined in advance has not elapsed since the occurrence of the print aborting factor (NO in the step S1012), the print job processing unit 111 erases data relating to the print job data 305 temporarily stored in the storage unit 109 and the ongoing print job 303 used as intermediate data (step S1013) and terminates the process.

In the secure printing control process in FIG. 10, when a print aborting factor has occurred, and a time period determined in advance has elapsed since the occurrence of the print aborting factor, a printing process is aborted. Moreover, a plurality of references for determining that the progress of a print job has slowed down is provided, and the image forming apparatus 102 can be configured such that the user can select one from the plurality of references via an initial setting screen. As a result, demands of the user for various usage patterns can be satisfied to the maximum extent possible.

According to the present embodiment, a print job is started after authentication is performed based on a password, but when a printing process on the print job is suspended due to occurrence of a print aborting factor, the ongoing print job is aborted to bring the image forming apparatus into a standby state which is a state before authentication is performed based on the password.

Namely, the image forming apparatus 102 is brought back to a time point when the print job data 305 using secure printing is sent from the PC 101 and stored in the storage unit 109 of the image forming apparatus 102. Therefore, in order to obtain the printed matter 304 by executing the aborted print job once again, it is necessary for the user to execute the print job once again by performing a printing operation in which he or she inputs the password once more.

As a result, printed matter is never accidentally output, and additionally, when printing is performed once again, a printing operation is required to be performed once more. Therefore, safety and reliability of secure printing function can be further improved with consideration given to the risk of the user leaving the image forming apparatus during execution of a print job.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-191662 filed Sep. 17, 2013, which is hereby incorporated by reference herein in its entirety.

What is claimed is:

1. An image forming apparatus having a secure printing function, comprising:
a storage unit configured to store print data, which is received from an external apparatus, as print data using the secure printing function;
a printing unit configured to execute a printing process on the print data in response to a printing instruction which the image forming apparatus have received from a user;
a detection unit configured to detect a print aborting factor during execution of the printing process;
a control unit configured to abort the printing process in response to detection of the print aborting factor, and store the print data once again as print data using the secure printing function in said storage unit.

2. The image forming apparatus according to claim 1, wherein the print aborting factor is selected by the user.

3. The image forming apparatus according to claim 1, wherein in a case where the printing process has been aborted by said control unit, an indication showing that the printing process having been aborted is displayed on a display unit, and at least one of the print aborting factor that has occurred and an indication that it is necessary to perform a printing operation once again when carrying out a printing process once again is displayed on the display unit.

4. The image forming apparatus according to claim 1, wherein said control unit aborts the printing process when the print aborting factor has occurred, and a time period determined in advance has elapsed since the occurrence of the print aborting factor.

5. The image forming apparatus according to claim 4, wherein the time period is determined with respect to each print aborting factor.

6. The image forming apparatus according to claim 1, wherein the print aborting factor is at least one selected from the following: warm-up of the image forming apparatus, color adjustment, temperature adjustment, cleaning process, return from sleep mode, shortage of consumables such as toner and printing sheets, and retention of other preceding printing processes.

7. A control method for an image forming apparatus having a secure printing function, comprising:
a storage step of storing print data, which is received from an external apparatus, as print data using the secure printing function;
a printing step of executing a printing process on the print data in response to a printing instruction which the image forming apparatus have received from a user;
a detection step of detecting a print aborting factor during execution of the printing process;
a control step of aborting the printing process in response to detection of the print aborting factor, and storing the print data once again as print data using the secure printing function.

8. The control method according to claim 7, wherein the print aborting factor is selected by the user.

9. The control method according to claim 8, wherein in a case where the printing process has been aborted in said control step, an indication showing that the printing process has been aborted is displayed on a display unit, and at least one of the print aborting factor that has occurred and an indication that it is necessary to perform a printing operation once again when carrying out a printing process once again is displayed on the display unit.

10. The control method according to claim 7, wherein in said control step, the printing process is aborted when the print aborting factor has occurred, and a time period determined in advance has elapsed since the occurrence of the print aborting factor.

11. The control method according to claim 10, wherein the time period is determined with respect to each print aborting factor.

12. The control method according to claim 7, wherein the print aborting factor is at least one selected from the following: warm-up of the image forming apparatus, color adjustment, temperature adjustment, cleaning process, return from sleep mode, shortage of consumables such as toner and printing sheets, and retention of other preceding printing processes.

13. A non-transitory computer-readable storage medium storing a program for causing a computer to execute a control method for an image forming apparatus having a secure printing function, the control method comprising:
a storage step of storing print data, which is received from an external apparatus, as print data using the secure printing function;
a printing step of executing a printing process on the print data in response to a printing instruction which the image forming apparatus have received from a user;
a detection step of detecting a print aborting factor during execution of the printing process;
a control step of aborting the printing process in response to detection of the print aborting factor, and storing the print data once again as print data using the secure printing function.

14. The storage medium according to claim 13, wherein the print aborting factor is selected by the user.

15. The storage medium according to claim 13, wherein in a case where the printing process has been aborted in said control step, an indication showing that the printing process has been aborted is displayed on a display unit, and at least one of the print aborting factor that has occurred and an indication that it is necessary to perform a printing operation once again when carrying out a printing process once again is displayed on the display unit.

16. The storage medium according to claim 13, wherein in said control step, the printing process is aborted when the print aborting factor has occurred, and a time period determined in advance has elapsed since the occurrence of the print aborting factor.

17. The storage medium according to claim 16, wherein the time period is determined with respect to each print aborting factor.

18. The storage medium according to claim 13, wherein the print aborting factor is at least one selected from the following: warm-up of the image forming apparatus, color adjustment, temperature adjustment, cleaning process, return from sleep mode, shortage of consumables such as toner and printing sheets, and retention of other preceding printing processes.
